(19) United States
(12) Patent Application Publication
(10) Pub. No.: US 2017/0085931 A1
(43) Pub. Date: Mar. 23, 2017

(54) ELECTRONIC APPARATUS AND METHOD FOR PROVIDING CONTENT THEREOF

(71) Applicant: SAMSUNG ELECTRONICS CO., LTD., Suwon-si (KR)

(72) Inventors: Seok-hyun JEONG, Suwon-si (KR); Jeong-hyo SOHN, Gimpo-si (KR); Seong-jin MOON, Suwon-si (KR); Sang-shin PARK, Seoul (KR); Young-jin LEE, Suwon-si (KR); Hee-jung CHUNG, Seoul (KR); Myung-kwan CHOI, Suwon-si (KR); Do-young KIM, Seoul (KR); Scott Seongwook LEE, Suwon-si (KR); Eun-joo CHO, Hwaseong-si (KR)

(21) Appl. No.: 15/263,576

(22) Filed: Sep. 13, 2016

Related U.S. Application Data
(60) Provisional application No. 62/221,813, filed on Sep. 22, 2015.

(30) Foreign Application Priority Data
Nov. 20, 2015 (KR) 10-2015-0163505

(51) Int. Cl. H04N 21/262; H04N 21/472; H04N 21/2385; H04N 21/431; H04N 21/482; H04N 21/458; H04N 21/845

(52) U.S. Cl. CPC H04N 21/262; H04N 21/458; H04N 21/47202; H04N 21/8456; H04N 21/431; H04N 21/4821; H04N 21/2385

(57) ABSTRACT

An electronic apparatus and a content providing method thereof are provided. The content providing method of an electronic apparatus includes receiving schedule information from an external server, where a plurality of VOD contents are allocated to a plurality of channels, receiving, in response to a command to select a channel corresponding to a first VOD content from among the plurality of VOD contents being input, the first VOD content from a content providing server based on address information of the first VOD content included in the schedule information, and outputting the received first VOD content.

### CROSS-REFERENCE TO RELATED APPLICATION

This application is based on and claims priority under 35 U.S.C. §119 to U.S. Provisional Patent Application No. 62/221,813, filed on Sep. 22, 2015, and Korean Patent Application No. 10-2015-0163505, filed in the Korean Intellectual Property Office on Nov. 20, 2015, the disclosure of which is incorporated by reference herein in its entirety.

### BACKGROUND

1. Field

Apparatuses and methods consistent with aspects of one or more example embodiments relate to an electronic apparatus and a content providing method thereof, and an electronic apparatus configured to allocate a VOD content to a broadcast channel and provide the VOD content to a user, and a content providing method thereof.

2. Description of Related Art

Conventionally, users watched various image contents through at least one of terrestrial channels, cable channels, and satellite channels in the related art. Also, the users watched contents that they could not watch through general terrestrial channels, cable channels, and satellite channels, as VOD contents through the Internet.

However, conventionally, a method of accessing terrestrial channels, cable channels, and satellite channels and a method of accessing VOD contents were independent from each other. Specifically, conventionally, terrestrial channels, cable channels, and satellite channels were provided in a single channel list, and to watch a VOD content, there was inconvenience in use to have to enter an additional menu to watch or access the Internet to watch via web browser.

### SUMMARY

An aspect of example embodiments is to address the aforementioned problems, for example, to provide an electronic apparatus configured to allocate channel numbers to a plurality of VOD contents, and to allow a user to access the VOD contents more conveniently through the allocated channel numbers, and a content providing method thereof.

According to an aspect of one or more example embodiments, a content providing method in an electronic apparatus is provided, including: receiving schedule information from an external server, wherein a plurality of VOD contents are allocated to a plurality of channels; receiving a command selecting a channel from among the plurality of allocated channels, the selected channel corresponding to a first VOD content from among the plurality of VOD contents; accessing a content providing server based on address information of the first VOD content which is included in the schedule information; receiving the first VOD content beginning from a screen corresponding to a time point of when the command is input; and outputting the received first VOD content.

The schedule information may include a channel number, a channel name, a name of a program to be broadcasted for each time slot, and address information of the program to be broadcasted for each time slot.

The schedule information may further include schedule information of at least two of a plurality of channels corresponding to the plurality of VOD contents, terrestrial channels, satellite channels and cable channels.

The method may include providing an integrated channel list including at least one of the plurality of channels corresponding to the plurality of VOD contents, the terrestrial channels, the satellite channels, and the cable channels.

The first VOD content may include at least one program, and the outputting may include outputting a screen of a program beginning from a screen corresponding to a time point of when the command is input, from among a plurality of programs of the first VOD content.

The outputting may include outputting a UI to control a reproduction time point of the first VOD content on the screen, and the method may include, controlling a reproduction time point of the first VOD content and outputting the first VOD content in response to a command being received via the UI to change a reproduction time point of the first VOD content.

The outputting may further include outputting a list of programs to select a program different from a program of the first VOD content together with the first VOD currently being output on the screen.

The outputting may further include outputting a display item to identify information related to the first VOD content together with the first VOD content currently being output on the screen.

The outputting may further include, in response to the selected program of the first VOD content being a subscription-based program, outputting a payment menu to view the selected program of the first VOD content together with the first VOD content.

According to another aspect of one or more example embodiments, an electronic apparatus is provided, including: communication circuitry configured to communicate with an external apparatus; input circuitry configured to receive input of a command; output circuitry configured to output a content; and a processor configured to control the communication circuitry to receive schedule information from an external server, wherein a plurality of VOD contents are allocated to a plurality of channels, to control selection of a channel corresponding to a first VOD content from among the plurality of VOD contents received via the input circuitry in response to the command, to control the communication circuitry to access a content providing server based on address information of the first VOD content which is included in the schedule information, and to receive a first VOD content beginning from a screen corresponding to a time point of when the command is input, and to control the output circuitry to output the received first VOD content.

The schedule information may include a channel number, a channel name, a name of a program to be broadcasted for each time slot, and address information of the program to be broadcasted for each time slot.

The schedule information may further include schedule information of at least two of a plurality of channels corresponding to the plurality of VOD contents, terrestrial channels, satellite channels, and cable channels.

The processor may be configured to control the output circuitry to provide an integrated channel list including at least one of the plurality of channels corresponding to the plurality of VOD contents, the terrestrial channels, the satellite channels, and the cable channels.

The first VOD content may include at least one program, and the processor may be configured to control the output circuitry to output a screen of a program beginning from a screen corresponding to a time point of when the command is input, from among the plurality of programs of the first VOD content.

The processor may be configured to control the output circuitry to include and output a UI to control a reproduction time point of the first VOD content on the screen, and to change a reproduction time point of the first VOD content in response to a command being input through the UI, to control the output circuitry to control a reproduction time point of the first VOD content and to output the first VOD content.

The processor may be further configured to control the output circuitry to output a list of programs to select a program different from a program of the first VOD content together with the first VOD content currently being output on the screen.

The processor may be further configured to control the output circuitry to output a display item to identify information related to the first VOD content together with the first VOD content currently being output on the screen.

The processor may be configured to control the output circuitry to output a payment menu to view the selected program of the first VOD content together with the first VOD content in response to the selected program of the first VOD content being a subscription-based program.

According to another aspect of one or more example embodiments, a schedule information providing server is provided, including: communication circuitry configured to receive information on a plurality of VOD contents from an external content providing server; and a processor configured to allocate the plurality of VOD contents to a plurality of channels based on the information on a plurality of VOD contents which is received from the external content providing server, to generate schedule information on the plurality of VOD contents allocated to the plurality of channels, and to control the communication circuitry to transmit the generated schedule information to an external electronic apparatus.

According to another aspect of one or more example embodiments, a content providing system is provided, including: a content providing server configured to store a plurality of VOD contents and information on the plurality of VOD contents; a schedule information providing server configured to receive the information on the plurality of VOD contents from the content providing server, to allocate channels to the plurality of VOD contents, and to generate schedule information for the plurality of VOD contents; and an electronic apparatus configured to receive schedule information from the schedule information providing server and to provide a plurality of channels corresponding to the plurality of VOD contents along with other channels in an integrated channel list based on the schedule information.

According to aspects of various example embodiments, a channel corresponding to a VOD content is provided together with general channels. Accordingly, the user may watch a VOD content more conveniently and intuitively.

### BRIEF DESCRIPTION OF THE DRAWINGS

The above and/or other aspects of one or more example embodiments will be more apparent from the following detailed description, taken in conjunction with the accompanying drawings, in which like reference numerals refer to like elements, and wherein:

FIG. 1 is a diagram illustrating an example content providing system;

FIG. 2 is a block diagram illustrating an example configuration of an electronic apparatus;

FIG. 3 is a block diagram illustrating an example configuration of an electronic apparatus;

FIGS. 4A, 4B, 5A, 5B and 6 to 10 are diagrams illustrating various example screens provided in an electronic apparatus to view VOD contents allocated to a plurality of channels;

FIG. 11 is a flowchart illustrating an example method of providing a content in an electronic apparatus; and

FIG. 12 is a sequence diagram illustrating an example content providing method in a content providing system; and

FIG. 13 is a block diagram illustrating an example configuration of a schedule information providing server.

### DETAILED DESCRIPTION

Hereinafter, the terms used in the description will be described briefly and the example embodiments will be described in greater detail.

With respect to the terms used in an example embodiment of the disclosure, general terms currently widely used are selected in view of function with respect to the disclosure; however, the terms may vary according to an intention of a technician practicing in the pertinent art, an advent of new technology, etc. In specific cases, terms may be chosen arbitrarily, and in this case, definitions thereof will be described in the description of the corresponding disclosure. Accordingly, the terms used in the description should not necessarily be construed as simple names of the terms, but be defined based on meanings of the terms and overall contents of the present disclosure.

The example embodiments may vary, and may be provided in different example embodiments. Various example embodiments will be described with reference to accompanying drawings. However, this does not necessarily limit the scope of the example embodiments to a specific embodiment form. Instead, modifications, equivalents and replacements included in the disclosed concept and technical scope of this description may be employed. While describing example embodiments, if it is determined that the description regarding a known technology obscures the gist of the invention, a detailed description may be omitted.

In the present disclosure, relational terms such as first and second, and the like, may be used to distinguish one entity from another entity, without necessarily implying any actual relationship or order between such entities.

The terms used in the following description are provided to explain various example embodiments and are not intended to limit the scope of rights. A singular term includes a plural form unless it is intentionally written that way. The terms, “include,” “comprise,” “is configured to,” etc. of the description are used to indicate the existence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware (e.g., circuitry), firmware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

In an example embodiment, in the case where a part is “connected” to another part, the case also includes a case where the part is “electrically connected” to the other part with another element interposed therebetween. In the case where a part “includes” or “comprises” an element, it may be interpreted as, unless otherwise specified, further including another element, not excluding the other element.

The example embodiments of the disclosure will be described in greater detail below in a manner that will be understood by one of ordinary skill in the art. However, the example embodiments may be implemented as various different forms, and is not limited to the example embodiments described herein. In the drawings, parts that are not relevant to the description may be omitted to clearly describe the embodiments, and like drawing reference numerals are used for the like elements throughout the specification.

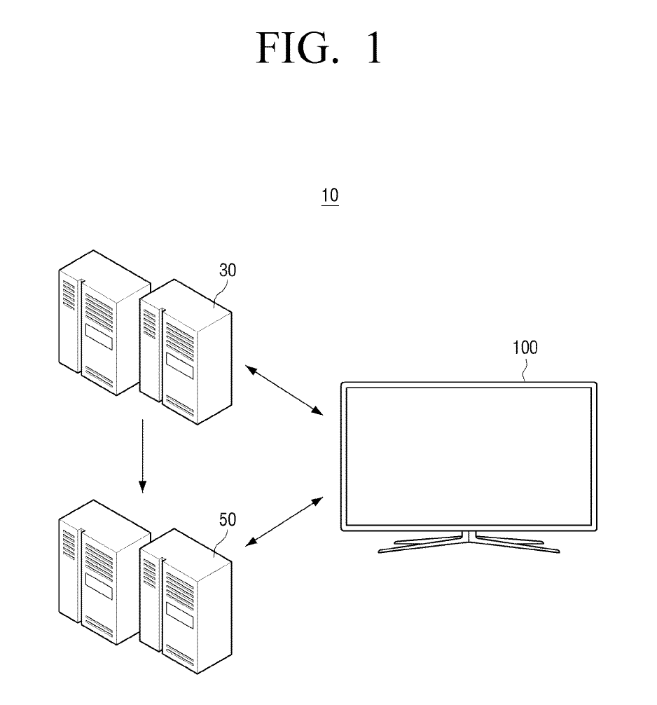

Certain example embodiments are described in higher level detail below with reference to the accompanying drawings. FIG. 1 is a diagram illustrating an example content providing system 10. The content providing system 10 includes, for example, a content providing server 30, schedule information providing server 50, and an electronic apparatus 100. The electronic apparatus 100 may, for example, be a TV, but this is only an example. The electronic apparatus 100 may be embodied as, as non-limiting examples, a set-top box, a smart phone, a tablet PC, a notebook PC, and a desktop PC, etc.

The content providing server 30 may be configured to provide information on a (Video On-Demand) VOD content to the schedule information providing server 50. The information on a VOD content may include, for example, a name, producer, cast, reproduction time of the VOD content.

In FIG. 1, only one content providing server 30 to provide a VOD content is illustrated, but this is only an example. The content providing server 30 may be embodied as, as non-limiting examples, two or more servers. The content providing server 30 may be provided for each content provider.

The schedule information providing server 50 may be configured to allocate channel numbers to a plurality of VOD contents based on received information on VOD content, to map channel numbers, channel names, names of broadcast programs for each time slot, and address information of broadcast programs for each time slot, and to generate schedule information, and to provide the generated schedule information to an external electronic apparatus 100.

In the aforementioned aspect of one or more example embodiments, generating only schedule information on a plurality of VOD contents and providing the generated schedule information to the electronic apparatus 100 was described, but this is only an example. The schedule information providing server 50 may be configured to, as non-limiting examples, acquire not only information on a VOD content but also information of terrestrial channels, cable channels, satellite channels, etc. and to generate integrated schedule information where schedule information of a channel corresponding to VOD content, terrestrial channels, cable channels, and satellite channels are integrated together and provide the generated integrated schedule information to the electronic apparatus 100.

The electronic apparatus 100 may be configured to store the received schedule information. When a command (e.g., a user command) to select a first VOD content from among the plurality of VOD contents is input, the electronic apparatus 100 may access the content providing server 30 based on address information corresponding to the first VOD content which is included in the schedule information, and receive the first VOD content from the content providing server 30 and output the received first VOD content. Accordingly, with only a manipulation of changing channels during reception of general broadcasts, the user may receive a VOD content and watch the VOD content without a use inconvenience to enter an additional menu to watch the content or to access the Internet to watch the content via web browser.

If the electronic apparatus 100 is a TV, the electronic apparatus 100 may display the first VOD content immediately. If the electronic apparatus 100 is a set-top box, the electronic apparatus 100 may provide the first VOD content to an electronic apparatus having an external display unit. In this example, the electronic apparatus 100 may provide a screen of a program of the first VOD content which corresponds to a time point of when a command is input.

According to the above aspects of various example embodiments, a user may watch a VOD content conveniently using the same or similar method as accessing other terrestrial channels, cable channels, and satellite channels.

In the above aspect of one or more example embodiments, the content providing server 30 and the schedule information providing server 50 which are separate from each other is described, but this is only an example. The servers may be embodied as, as a non-limiting example, one server, and the schedule information providing server 50 may be mounted and provided in the form of a module in the electronic apparatus 100.

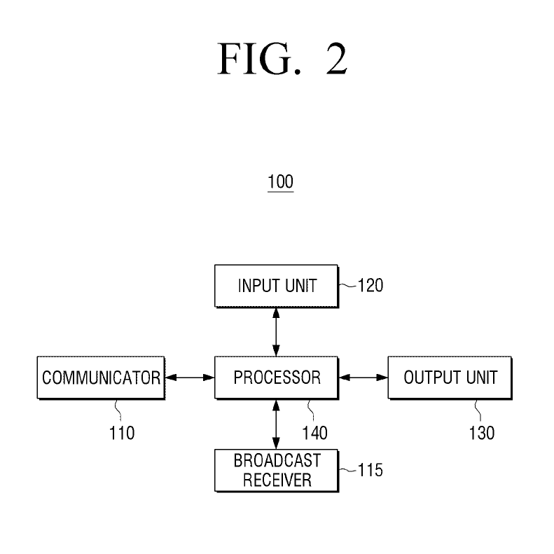

FIG. 2 is a block diagram illustrating an example configuration of an electronic apparatus 100. As illustrated in FIG. 2, the electronic apparatus 100 includes a communicator (e.g., including communication circuitry) 110, a broadcast receiver 115, an input unit (e.g., including input circuitry, such as, for example, a key, button, touch pad, etc.) 120, an output unit (e.g., including output circuitry) 130, and a processor 140. However, the elements illustrated in FIG. 2 are merely examples, and the elements are not limited thereto. At least one of the aforementioned elements may be omitted and another functional unit may be added as necessary.

The communicator 110 may be configured to communicate with various external devices. For example, the communicator 110 may receive schedule information from the external schedule information providing server 50. The communicator 110 may receive a VOD content from the external content providing server 30.

The broadcast receiver 115 receives broadcast content from an external source. For example, the broadcast receiver 115 may receive broadcast content regarding terrestrial channels, satellite channels, and cable channels according to a user selection. The broadcast receiver 115 may receive not only the broadcast content but also information on the broadcast content (including schedule information).

The input unit 120 may be configured to receive input of, for example, a user command to control the electronic apparatus 100. For example, the input unit 120 may receive input of a user command to select a channel corresponding to VOD content.

The output unit 130 may be configured to output a VOD content received from the content providing server 30. When the electronic apparatus 100 is an electronic apparatus that has a display unit (e.g., a display panel and display driving circuitry), such as a TV, the output unit 130 may display the VOD content immediately. However, when the electronic apparatus 100 is an electronic apparatus that does not include a display unit, such as a set-top box, the output unit 130 may output the VOD content to an external electronic apparatus.

The processor 140 may be configured to control overall operations of the electronic apparatus 100. For example, the processor 140 may be configured to control the communicator 110 to receive schedule information where a plurality of VOD contents are allocated to a plurality of channels, from an external server. When a user command to select a channel corresponding to a first VOD content from among a plurality of VOD contents is input through the input unit 120, the processor 140 may be configured to control the communicator 110 to receive the first VOD content from the content providing server 30 based on address information of the first VOD content which is included in the schedule information. The processor 140 may be configured to control the output unit 30 to output the received first VOD content.

For example, the processor 140 may be configured to control the communicator 110 to receive schedule information from an external schedule information providing server 50. The schedule information is information where a plurality of VOD contents are allocated to a plurality of channels, and may include, for example, address information of a content providing server 50 to receive channel numbers, channel names, names of programs to be broadcasted for each time slot, and programs to be broadcasted for each time slot. The schedule information may further include various additional information related to a VOD content (for example, plot information, production staff information, cast information, related works information, fee information, etc.).

According to another example embodiment, the processor 140 may be configured to receive schedule information from the schedule information providing server 50, but this is only an example. The processor 140 may be configured to control the communicator 110 to receive integrated schedule information including schedule information on a plurality of channels corresponding to a plurality of VOD contents, terrestrial channels, satellite channels, and cable channels.

When a user command to generate a channel list is input, the processor 140 may be configured to control the output unit 130 to provide a channel list including at least one of the plurality of channels corresponding to a plurality of VOD contents and the terrestrial channels, the cable channels, and the satellite channels. In this example, the plurality of channels corresponding to a plurality of VOD contents may be allocated to channel numbers different from those of the terrestrial channels, the cable channels, and the satellite channels and form a channel group, but this is only an example. The plurality of channels may be allocated in the intervals within the terrestrial channels, the cable channels, and the satellite channels, and have channel numbers that are adjacent to each other.

According to another example embodiment, channel numbers of a plurality of channels may be allocated to one of a plurality of channel groups according to a type of content, regardless of the source of content. For example, regardless of the terrestrial channel, satellite channel, cable channel, channel corresponding to VOD content, channels to provide contents related to current affairs are allocated to a first channel group, channels to provide news-related contents are allocated to a second channel group, and channels to provide sports-related contents are allocated to a third channel group.

In this example, when channel numbers of a plurality of channels corresponding to a plurality of VOD contents are identical to at least one channel number of the above terrestrial channel, cable channel, and satellite channel, the processor 140 may be configured to control the output unit 130 to distinguish the plurality of channel numbers corresponding to the plurality of VOD contents from other channels and provide the distinguished channel numbers.

When a user command to select a channel corresponding to a first VOD content from among channels corresponding to a plurality of VOD contents is input through a channel list, the processor 140 may be configured to access the content providing server 30 and receive the first VOD content based on address information of the first VOD content which is included in schedule information. In this example, the first VOD content may include at least one program. For example, when the first VOD content is “Drama AAA,” the first VOD content may include “Drama AAA Episode 1,” “Drama AAA Episode 2,” and so on.

For example, the processor 140 may be configured to control the output unit 10 to output a screen of a plurality of programs beginning from a screen provided in the content providing server 30 at a time point of when the user command is input, from among the plurality of programs of the first VOD content.

For example, in the state that it is stored on schedule information such that a third program of the first VOD content will be provided from 3 PM, when a user command to select a channel number corresponding to the first VOD content is input at 3:20 PM, the electronic apparatus 100 may receive the third program beginning from a screen after a lapse of 20 minutes of the third program streamed in the content providing server providing the first VOD content and reproduce the received third program.

By providing content based on the schedule information, the content providing server 30 may provide same content according to a predetermined schedule and achieve simplified design and efficient storage space regardless of the type of content according to different devices and type of electronic apparatus 100 accessing without storing or managing a reproduction time point. There is no limitation thereto.

A UI to control reproduction of a program may be provided to display a play/stop item, a fast forward item, a rewind item, etc. so that a user may change a reproduction time point of content provided in the content providing server 30 according to a schedule according to a user selection and watch the content. In this example, the content providing server 30 may individually manage a reproduction time point of the device, and carry out a process according to a procedure of payment according to a subscription-based service, etc.

The processor 140 may be configured to control the output unit 130 to receive a program list to recommend another program related to programs of the first VOD content currently being output on the screen and output together the received program list. Accordingly, a user may watch the other program related to the program currently being provided.

The processor 140 may be configured to control the output unit 130 to output a display item to identify information related to the first VOD content currently being output on the screen together with the first VOD content. For example, the processor 140 may be configured to control the output unit 130 to output a display item to identify various information including plot information of the first VOD content, cast information, production staff information, related news information, etc. together with the first VOD content.

When a selected program of the first VOD content is a subscription-based program, the processor 140 may be configured to control the output unit 130 to output a payment menu to watch the selected program of the first VOD content.

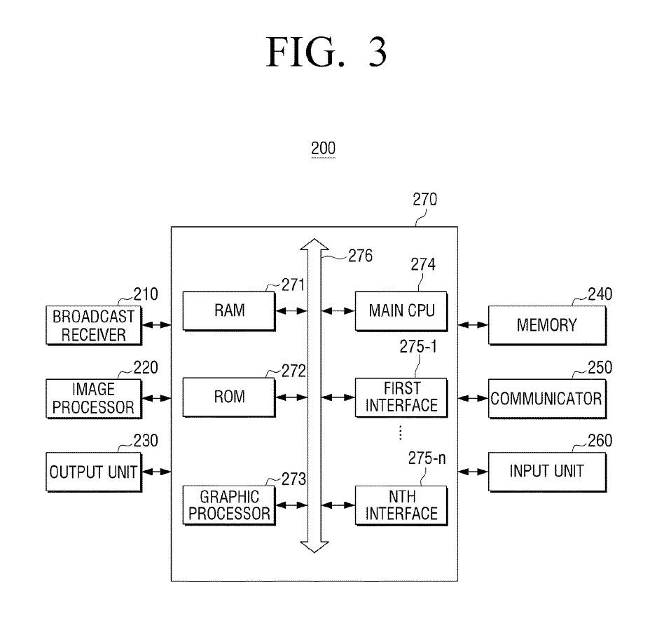

Example embodiments are described in greater detail below with reference to FIGS. 3 to 10. FIG. 3 is a block diagram illustrating an example configuration of an electronic apparatus 200. As illustrated in FIG. 2, the electronic apparatus 200 includes, for example, a broadcast receiver 210, an image processor (e.g., including processing circuitry) 220, an output unit (e.g., including output circuitry) 230, a memory 240, a communicator (e.g., including communication circuitry) 250, an input unit (e.g., including input circuitry) 260, and a controller (e.g., including processing circuitry) 270.

FIG. 3 illustrates various features in a comprehensive manner, taking example of an apparatus including various functions, such as a content providing function, an image outputting function, etc. However, certain example embodiments may omit or change some of the features or further include another feature.

The broadcast receiver 210 receives various image contents from an external source. For example, the broadcast receiver 210 may receive broadcast content from an external broadcasting station through a tuner, a cable terminal, a satellite communication module, and the like.

The image processor 220 is configured to perform image processing on image data acquired from the broadcast receiver 20. The image processor 220 may be configured to perform various image processing, such as decoding, scaling, noise filtering, frame rate conversion, resolution conversion, etc.

The output unit 230 outputs images which are output from the image processor 220. For example, when the output unit 230 is realized as a display unit, the output unit 230 displays at least one of broadcast contents received from the broadcast receiver 210 and various UIs processed in a graphic processor 273. For example, the output unit 230 may output a VOD content and a channel list that includes channels corresponding to the VOD content. The output unit 230 may be realized as, as a non-limiting example, an output port to transmit image data to an external apparatus.

The output unit 230 may not only output images but also include a speaker or an audio output port to output audio, etc.

The memory 240 stores various modules to drive the electronic apparatus 200. For example, software that includes a base module, a sensing module, a communication module, a presentation module, a web browser module, and a service module, or the like, may be stored on the memory 240. The base module may include a basic module configured to process signals transmitted from different hardware included in the electronic apparatus 200 and to transmit the processed signals to an upper level module. The sensing module may include a module configured to collect information from various sensors and to analyze and manage the collected information, and may include a face recognition module, a voice recognition module, a motion recognition module, a NFC recognition module, and the like. The presentation module may include a module configured to configure a display, and may include a multimedia module to reproduce and output multimedia content, a UI, and a UI rendering module to perform graphic processing. The communication module may include a module to communicate with an external entity. The web browser module may refer, for example, to a module configured to perform Internet browsing and access a web server. The service module may include a module that includes various applications to provide various services.

As described above, the memory 240 may include various program modules, but some of the various program modules may also be omitted, changed, or added, according to a type and characteristics of the display apparatus 200. When the display apparatus 200 is realized as a tablet PC, for example, the base module may further include a GPS based position determination module to determine a position, and the sensing module may further include a sensing module to detect a user motion.

The memory 240 may be realized, as non-limiting examples, as various volatile or non-volatile memory.

The communicator 250 may communicate with various external apparatuses. The communicator 250 may include various communication chips, e.g., circuitry, such as, for example, a Wi-Fi chip, a Bluetooth chip, a NFC chip, a wireless communication chip, and the like. A Wi-Fi chip, Bluetooth chip, and NFC chip may communicate in a LAN method, Wi-Fi method, Bluetooth method, and NFC method. An NFC chip may refer, for example, to a chip that operates in a Near Field Communication (NFC) method which uses a 13.56 MHz-band from among various RF-ID frequency bands, such as 135 kHz, 13.56 MHz, 433 MHz, 860 to 960 MHz, and 2.45 GHz. When using the Wi-Fi chip or Bluetooth-chip, the communicator 250 may first transceive various connection information, such as an SSID, a session key, and the like, and connect to, using the information, communication and then transceive various information. A wireless communication chip may refer, for example, to a chip that communicates according to various communication protocols, such as an IEEE, a ZigBee, a 3rd Generation (3G), a 3rd Generation Partnership (3GP), a Long Term Evolution (LTE), and the like.

The communicator 250 may receive schedule information from an external schedule information providing server 50. The communicator 250 may also receive a VOD content selected by a user from the content providing server 30 in the form of streaming.

The input unit 260 receives a command to control an overall operation of the electronic apparatus 200. The input unit 260 may receive input of a user command to select a channel corresponding to a VOD content. The input unit 260 may be realized, as non-limiting examples, as a remote controller and another input apparatus to control the electronic apparatus 200, such as a pointing device, a mouse, a keyboard, a voice recognition apparatus, a motion recognition apparatus, a touch panel, and the like.

The processor 270 may be configured to control an overall operation of the electronic apparatus 200 using various programs stored in the memory 240.

The processor 20 may include, for example, a RAM 271, a ROM 272, a graphic processor (e.g., a GPU) 273, a main CPU 274, first to nth interfaces 275-1 to 275-n, and bus 276. In this example, a RAM 271, a ROM 272, a graphic processor 273, a main CPU 274, and first to nth interfaces 275-1 to 275-n may be connected to one another or communicate with one another via bus 276.

A command word set for booting a system, etc. are stored on the ROM 272. When a command to turn on power is input and power is supplied, the main CPU 274 copies an operating system (O/S) stored on the memory 240 according to a command word stored on the ROM 272, and executes the O/S to boot the system. When the booting is complete, the main CPU 274 copies various application programs stored on the memory 240, and executes the application programs copied onto the RAM 271 and performs various operations.

The graphic processor 273 generates a screen including various objects, such as an icon, an image, a text, and the like, using a computation unit and a rendering unit. The computation unit computes an attribute value, such as a coordinate value where each object is displayed, a form, a size, a color, and the like, according to a screen layout using a control command received from the input unit 260. The rendering unit creates a screen having various layouts including an object based on the attribute value computed by the computation unit. The screen is displayed within a display area of the output unit 230.

The main CPU 274 accesses the memory 240 and performs booting using the O/S stored on the memory 240. Then, the main CPU 274 performs various operations using various programs, contents, data, etc. stored on the memory 240.

The first to nth interfaces 275-1 to 275-n are connected to the aforementioned various features. One of the interfaces may be, as a non-limiting example, a network interface connected to an external apparatus via network.

The processor 20 may be configured to control the communicator 250 to receive schedule information where a plurality of VOD contents are allocated to a plurality of channels, from an external schedule information providing server 50. In this example, a VOD content may be, as a non-limiting example, an image content provided according to a user request, but not a broadcast content provided by an external broadcasting station in real time. The VOD content may also be, as a non-limiting example, an image content including at least one program or include a same type of multimedia content. The VOD content may be, as non-limiting examples, a VOD content for a particular drama comprising a plurality of programs, a VOD content for a particular entertainment program, and a VOD content for a same type of programs (for example, education, travel, etc.)

The above-mentioned one or more example embodiments describe that a VOD content is an image content; however, this is merely an example, and the content may be, as non-limiting examples, a music content, a photo content, an advertisement content, etc.

Schedule information may map information related to a plurality of VOD contents to a plurality of channel information and store the same. The schedule information may include, for example, a channel number, a channel name, a name of a broadcast program for each time slot, address information of a broadcast program for each time slot, and the like. For example, schedule information may store information as in Table 1 below:

TABLE 1

| | | Broadcast | Broadcast | Broadcast | Broadcast | Broadcast | Broadcast |
|---|---|---|---|---|---|---|---|
| | | program | program | program | program | program | program |
| Channel | Channel | at 12 o' | at 1 o' | at 2 o' | at 3 o' | at 4 o' | at 5 o' |
| number | name | clock | clock | clock | clock | clock | clock |
| 511 | Oh My | Episode 1 | Episode 2 | Episode 3 | Episode 4 | Episode 5 | Episode 6 |
| | Ghost | | | | | | |
| 512 | Finite | Episode | Episode | Episode | Episode | Episode | Episode |
| | Challenge | 600 | 601 | 602 | 603 | 604 | 605 |
| 513 | Comedy | Episode | Episode | Episode | Episode | Episode | Episode |
| | League | 111 | 112 | 113 | 114 | 115 | 116 |
| 514 | English | Passive | Active | Imperative | Past | Interrogative | Adverb |
| | Education | voice | voice | sentence | perfect | sentence | |
| | Broadcasting | | | | | | |

Other than the information indicated in Table 1, schedule information may include, as non-limiting examples, address information of a broadcast program for each time slot, information corresponding to the program, and the like.

The processor 270 may be configured to control the communicator 250 to receive integrated schedule information including schedule information of a plurality of channels corresponding to a plurality of VOD contents, terrestrial channels, satellite channels, and cable channels, from an external schedule information providing server 50.

Channel numbers for a plurality of VOD contents allocated to schedule information may be allocated to channel numbers that are different from channel numbers of terrestrial channels, cable channels, and satellite channels, to form a channel group, but this is only an example, and the plurality of VOD contents may be allocated, as a non-limiting example, in the intervals between terrestrial channels, cable channels, and satellite channels, to have channel numbers that are adjacent to each other. Channel numbers of a plurality of channels may be allocated to one of a plurality of channel groups according to a type of content, regardless of the source of content. For example, regardless of the terrestrial channel, satellite channel, cable channel, channel corresponding to a VOD content, channels that provide content related to current affairs are allocated to a first channel group, channels that provide news-related content are allocated to a second channel group, and channels that provide sports-related content are allocated to a third channel group. When a user command to generate a channel list is input through the input unit 260, the processor 270 may be configured to generate a channel list including a channel corresponding to a VOD content based on received schedule information. In this example, the processor 270 may be configured to generate a channel list including only the channel corresponding to the VOD content.

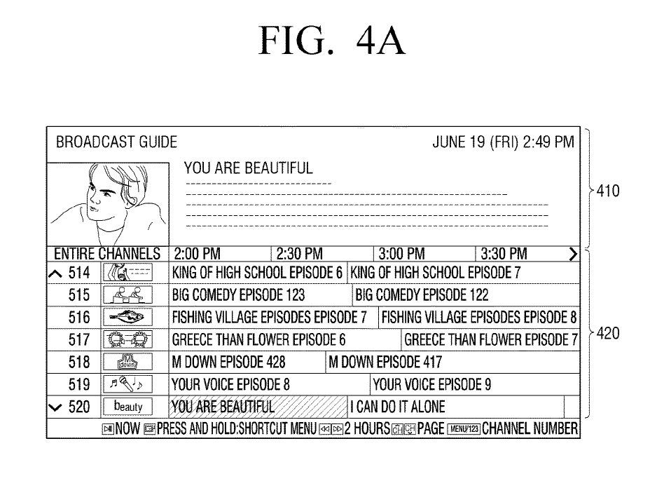

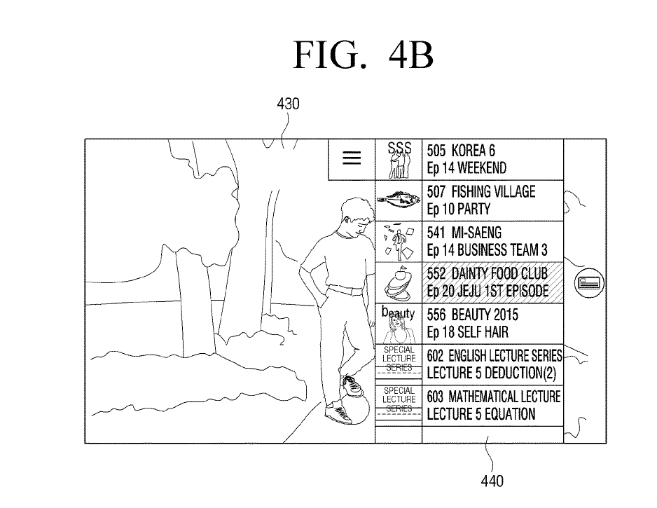

The processor 270 may be configured to generate a channel list as illustrated, for example, in FIG. 4A. For example, the processor 270 may be configured to control the output unit 230 to output a screen including, for example, a channel list area 420 which guides channels corresponding to a plurality of VOD contents and which guides broadcast programs for each time slot of a plurality of channels, and an area 410 which, for example, may represent information corresponding to a program with a highlighter. In this example, the channel list area 420 may include, as non-limiting examples, information corresponding to a channel number, a channel name, a thumbnail, and a name of a broadcasting program for each time slot, or the like.

The processor 270 may be configured to generate, as illustrated in FIG. 4B, a channel list 440 on an image content 430 currently being provided. In this example, the channel list 440 may include, as non-limiting examples, a channel number, a channel name, a thumbnail of a channel, a name of a program on air, and the like, but they are merely examples, and the channel list 440 may include, for example, other information corresponding to another channel or information corresponding to a program.

The processor 270 may be configured to provide not only a channel corresponding to a VOD content but also a channel list including all of terrestrial channels, satellite channels, and cable channels. For example, the processor 270 may be configured to constitute a channel list using schedule information including EPG information of channels received through the broadcast receiver 210 or the communicator 250 and information on VOD content.

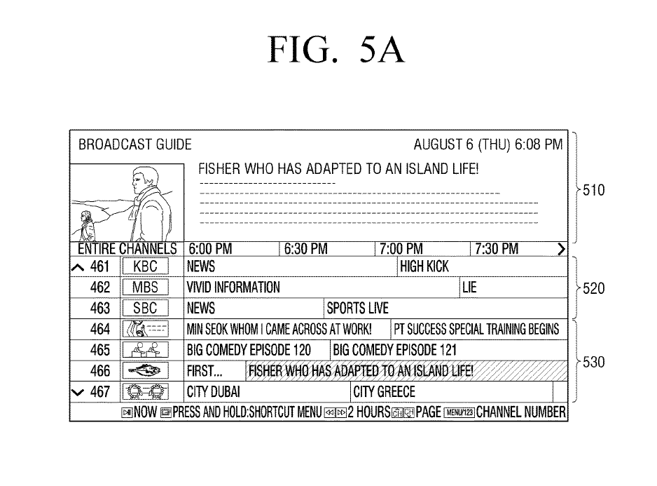

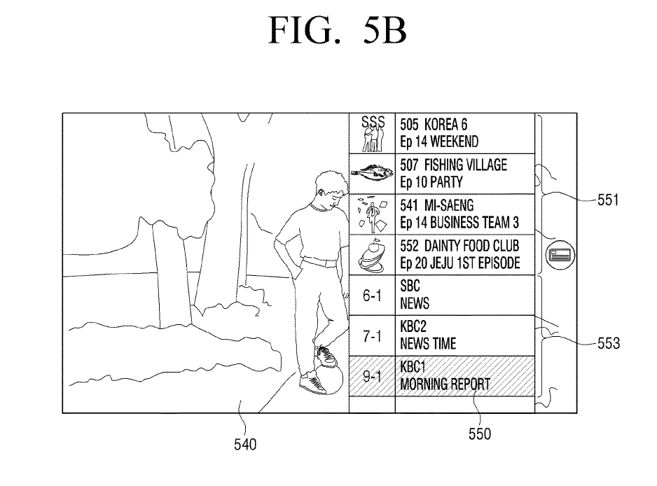

The processor 270 may be configured to generate a channel list as illustrated in FIG. 5A. For example, the processor 270 may be configured to control the output unit 230 to output a screen which includes a channel list area which includes an area 520 to select terrestrial channels and which includes an area 530 to select channels corresponding to VOD content, and an area 510 which provides information corresponding to a program in which a highlighter is placed. In this example, a channel number of a terrestrial channel and that of a channel corresponding to a VOD content may be different from each other, but this is only an example, and the channel number of the channel corresponding to a VOD content may be identical to that of a general terrestrial channel, cable channel, and satellite channel. In the case where channel numbers of a plurality of channels corresponding to a plurality of VOD contents are identical to at least one of channel numbers of a terrestrial channel, cable channel, and satellite channel, the processor 270 may be configured to distinguish a plurality of channel numbers corresponding to the plurality of VOD contents from other channels and provide the same. The processor 270 may be configured to control, as a non-limiting example, the output unit 230 to output together an indicator guiding that a VOD content is output to a plurality of channel numbers corresponding to a plurality of VOD contents.

The processor 270 may be configured to generate a channel list 550 on an image content 540 currently being provided as illustrated in FIG. 5B. In this example, the channel list 550 may include an area 551 in which a channel corresponding to a VOD content may be selected and an area 553 in which a terrestrial channel may be selected. The area 551 in which a channel corresponding to a VOD content may be selected may include a channel number, a channel name, a thumbnail of a channel, a name of a program on air, and the like, and the area 553 in which a terrestrial channel may be selected may include a channel number, a channel name, a name of a program on air, and the like.

As illustrated in FIGS. 5A and 5B, a channel which is different from a channel corresponding to a VOD content may be provided as a single channel list, thereby enabling a user to perceive the channel corresponding to a VOD content as a general channel and to select the VOD content more conveniently and intuitively.

The processor 270 may be configured to receive input of a user command to select a channel corresponding to a first VOD content from among a plurality of VOD contents through the input unit 260. In this example, a user command may be a user command to input a channel number through a remote controller or to move a highlighter displayed in a channel list and select a channel.

When a user command to select a channel corresponding to the first VOD content from among a plurality of VOD contents is input, the processor 270 may be configured to access the content providing server 30 based on address information corresponding to the first VOD content included in schedule information and receive the first VOD content.

In this example, the content providing server 30 may stream the first VOD content beginning from a screen of a program corresponding to a first VOD content corresponding to a time point of when a request is received from the electronic apparatus 200. As a non-limiting example, in the state that it is stored in schedule information such that a third program of the first VOD content is scheduled to broadcast from 3 PM, in response to a user command to select a channel number corresponding to the first VOD content being input at 3:10 PM, the content providing server 1030 may stream the first VOD content beginning from a screen of after a lapse of 10 minutes of the third program of the first VOD content.

The processor 270 may be configured to output, in response to image data related to the first VOD content being received from the content providing server 30, the received image data. In this example, if the electronic apparatus 200 is an electronic apparatus such as a TV which includes a display, the processor 270 may be configured to control the output unit 230 to display the first VOD content immediately. If the electronic apparatus 200 is an electronic apparatus such as a set-top box which does not include a display, the processor 270 may be configured to control the output unit 230 to output the first VOD content to an electronic apparatus that includes an external display.

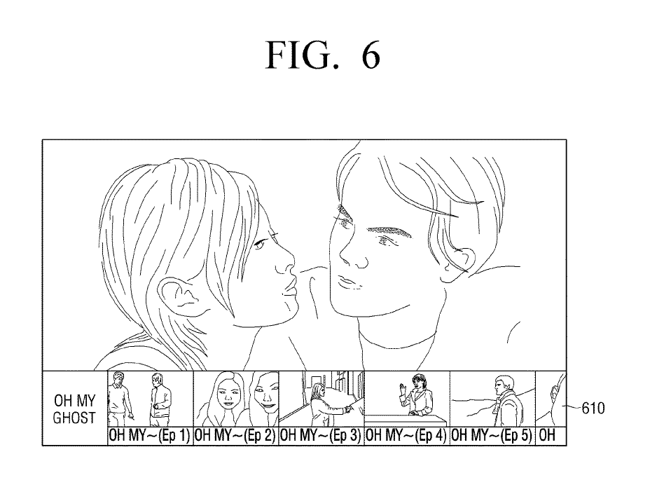

The processor 270 may be configured to control the output unit 230 not only to output a program of a first VOD content currently being provided but also to output a program list to select another program together with the VOD content. For example, when a user command to select a program of a VOD content called “Oh My Ghost Episode 3” is input, the processor 270 may be configured to control, as illustrated in FIG. 6, the output unit 230 to display a screen corresponding to “Oh My Ghost Episode 3,” and to output together a program list 610 to select another episode of “Oh My Ghost” at the bottom of a screen. When another episode of “Oh My Ghost” is selected through the program list 610, the processor 270 may be configured to receive the selected episode of “Oh My Ghost” and provide the received episode based on address information corresponding to the selected episode of “Oh My Ghost.”

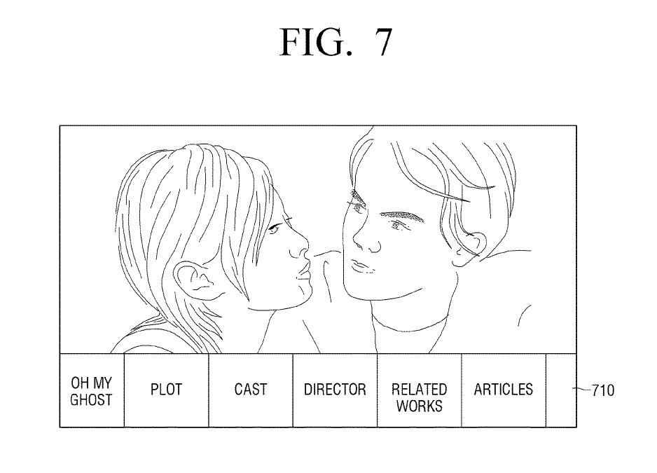

The processor 270 may be configured to control the output unit 230 not only to output a program of the first VOD content currently being provided but also to output a display item related to information related to the first VOD content together with the first VOD content. For example, when a user command is input to select a program of a VOD content called “Oh My Ghost Episode 3,” the processor 270 may be configured to control the output unit 230 to, as illustrated in FIG. 7, display a screen corresponding to “Oh My Ghost Episode 3,” and output a list 710 including a display item to identify information related to “Oh My Ghost” at the bottom of a screen together with the first VOD content. When a display item is selected on the list 710, the processor 270 may be configured to request the content providing server 30 or another server for information corresponding to the selected item and provide the information to a user.

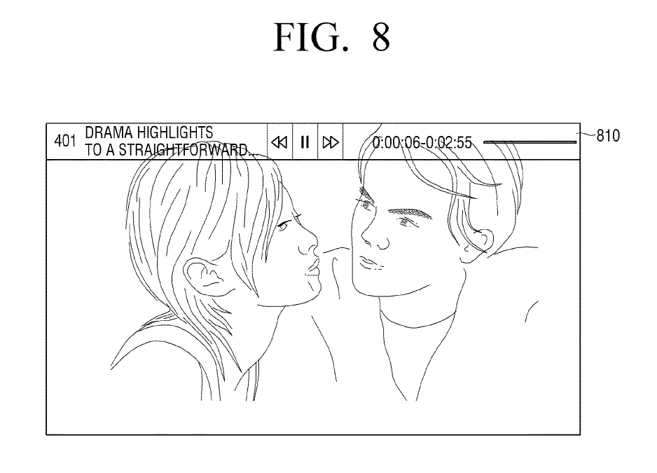

The processor 270 may be configured to control the output unit 230 not only to output a program of a first VOD content currently being provided but also to output a UI to control reproduction of the first VOD content together with the first VOD content. For example, when a user command to select a program of a VOD content called “Oh My Ghost Episode 3” is input, the processor 270 may be configured to control, as illustrated in FIG. 8, the output unit 230 to display a screen corresponding to “Oh My Ghost Episode 3,” and to output together a UI 810 to control reproduction of “Oh My Ghost Episode 3” at the top of the screen. In this example, the UI 810 may include, as non-limiting examples, information corresponding to a VOD content currently being reproduced, a play/stop item, a fast-forward item, a rewind item, a progress bar to control a reproduction time point, and the like.

As a non-limiting example, when a reproduction time point is to be changed through a progress bar included in the UI 810, the processor 270 may be configured to control the communicator 250 to transmit information corresponding to the changed reproduction time point to the content providing server 30. When the VOD content with the changed reproduction time point is received from the content providing server 30, the processor 270 may be configured to control the output unit 230 to reproduce the received VOD content.

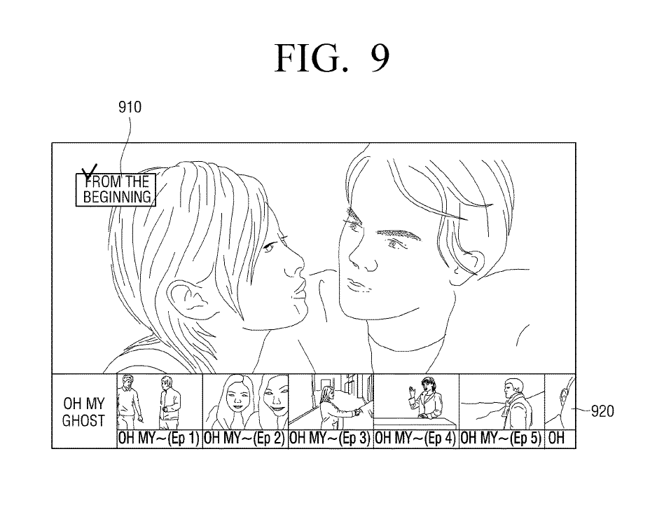

The processor 270 may be configured to control, as illustrated in FIG. 9, the output unit 230 to include a display item 910 to reproduce a program of the first VOD content selected on a screen from the beginning and to output the same. In this example, the display item 910 may be selected by a pointer, but this is only an example, and the display item 910 may be selected in a different method (for example, voice recognition).

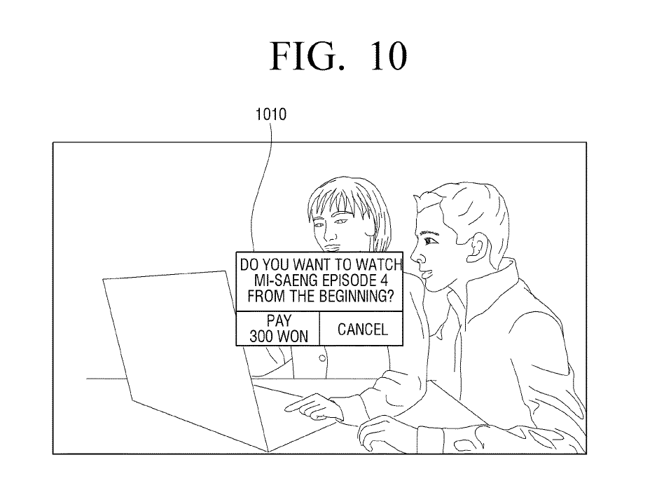

When a selected program of the first VOD content is a subscription-based program, the processor 230 may be configured to control, as illustrated in FIG. 10, the output unit 230 to output a payment menu 1010 to watch the selected program of the first VOD content.

The UIs described in FIGS. 6 to 10 may be output individually on a screen, but this is only an example, and two or more UIs may be output on a screen at the same time.

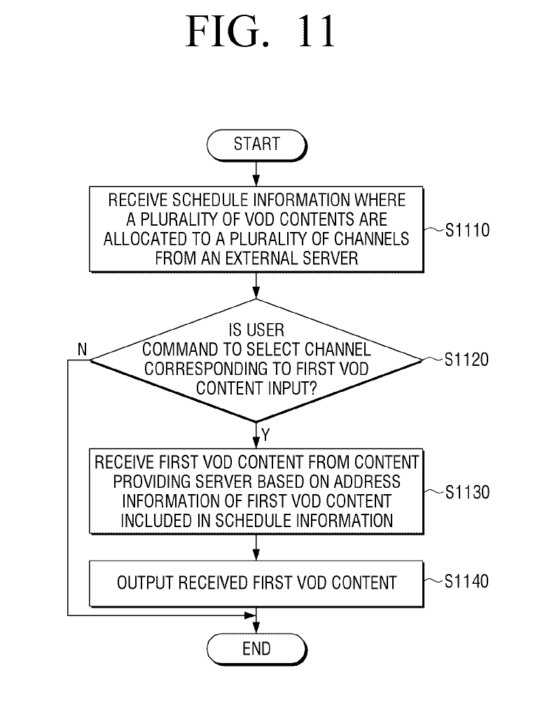

FIG. 11 is a flowchart illustrating an example method of providing content in the electronic apparatus 100.

The electronic apparatus 100 receives schedule information where a plurality of VOD contents are allocated to a plurality of channels, from an external server in operation 51110. In this example, the schedule information may include a channel number, a channel name, a name of a program for each time slot, address information of a broadcast program for each time slot, and the like. The schedule information may include, as a non-limiting example, additional information corresponding to a plurality of VOD contents other than the aforementioned information. The electronic apparatus 100 determines, in operation S1120, whether a user command to select a channel corresponding to the first VOD content is input. In this example, the electronic apparatus 100 may provide a channel list including a plurality of channels corresponding to a plurality of VOD contents and a user command to select a channel corresponding to the first VOD content may be input through the channel list. The channel list may include not only a plurality of channels corresponding to a plurality of VOD contents but also terrestrial channels, satellite channels, and cable channels.

When a user command to select a channel corresponding to the first VOD content is input S1120-Y, the electronic apparatus 100 receives, in operation 51130, the first VOD content from the content providing server 30 based on address information of the first VOD content included in schedule information. In this example, the electronic apparatus may receive the first VOD content beginning from a screen of a program of the first VOD content which corresponds to a time point of reception of the user command.

The electronic apparatus outputs, in operation 51140, the received first VOD content. When the electronic apparatus 100 is a TV, the electronic 100 may display the first VOD content immediately, and when the electronic apparatus 100 is a set-top box, the electronic apparatus 100 may output the first VOD content to an external display apparatus.

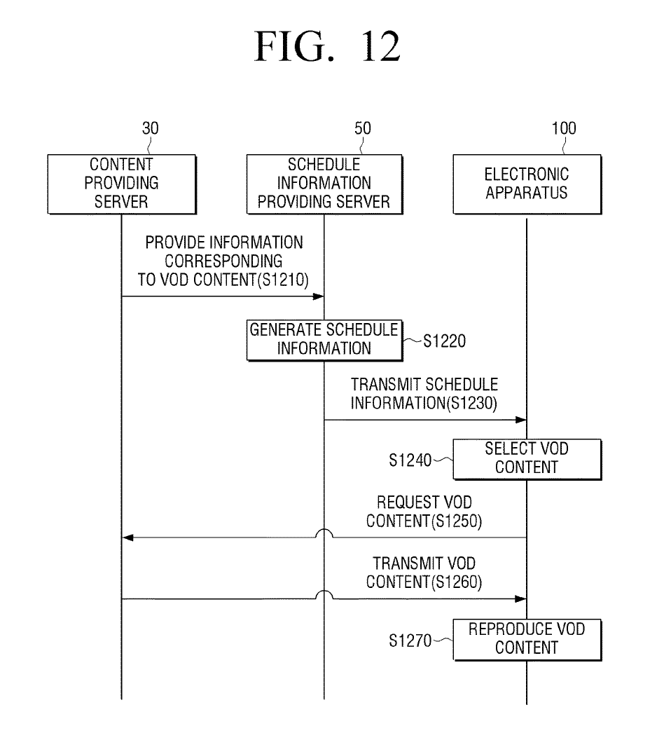

FIG. 12 is a sequence diagram illustrating an example content providing method in a content providing system 10.

The content providing server 30 provides, in operation 51210, information corresponding to a VOD content to the schedule information providing server 50.

The schedule information providing server 50 generates, in operation 51220, schedule information based on the information corresponding to the VOD content. In this example, information corresponding to a plurality of VOD contents may be mapped with channel information and stored in the schedule information. In this example, the schedule information may be not only schedule information corresponding to a VOD content but also integrated schedule information that includes schedule information corresponding to another channel (terrestrial channel, satellite channel, cable channel, etc.).

The schedule information providing server 50 transmits, in operation 51230, schedule information to the electronic apparatus 100.

The electronic apparatus 100 selects, in operation 51240, a VOD content according to an input user command based on the schedule information. For example, the electronic apparatus 100 may provide an integrated channel list to a user as illustrated in FIGS. 4A to 5B, and the user may select a channel corresponding to the VOD content through the channel list.

The electronic apparatus 100 requests, in operation 51250, the content providing server 30 for the selected VOD content.

The content providing server 30 transmits, in operation 51260, the selected VOD content to the electronic apparatus 100. In this example, the content providing server 30 may transmit the VOD content to the electronic apparatus 100 in a streaming method.

The electronic apparatus 100 reproduces, in operation 51270, the VOD content.

According to the various example embodiments, a user may perceive a channel corresponding to a VOD content as a general channel and may watch the VOD content more conveniently and intuitively.

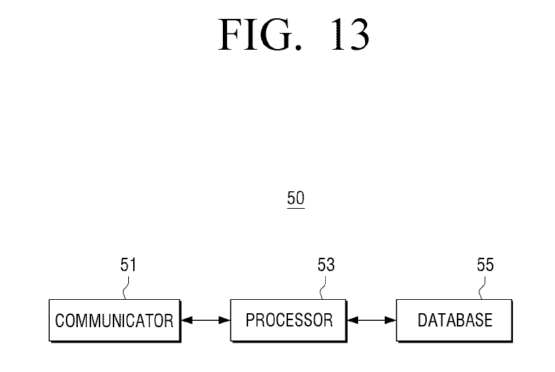

FIG. 13 is a block diagram illustrating an example configuration of the schedule information providing server 30. As illustrated in FIG. 13, the schedule information providing server 50 includes a communicator (e.g., including communication circuitry) 51, a processor (e.g., including processing circuitry such as, for example, a CPU) 53, and a database 55.

The communicator 51 may be configured to communicate with the external content providing server 30 and the electronic apparatus 100.

The communicator 51 may be configured to receive information on a VOD content from the external content providing server 30. The information on a VOD content may include a name, producer, cast, reproduction time, program information, and the like, of the VOD content.

The communicator 51 may be configured to acquire EPG information of terrestrial channels, satellite channels, and cable channels from various servers or broadcasting stations from outside. The EPG information may include a name of a program for each time slot to broadcast on terrestrial channels, satellite channels, and cable channels, and information corresponding to the program, and the like.

The communicator 51 may be configured to transmit schedule information to the external electronic apparatus 100.

The database 55 stores various data and programs. The database 55 may store information on a VOD content received through the communicator 51 and EPG information. The database 55 may store a program to generate schedule information.

The processor 53 may be configured to control an overall operation of a schedule information providing server. The processor 53 may be configured to generate schedule information based on information corresponding to a VOD content received from the external content providing server 30.

For example, the processor 53 may be configured to allocate a channel with respect to each of the VOD content based on the information corresponding to VOD content, and allocate a channel name and channel number with respect to the allocated channel. In this example, the channel number may be allocated according to a type, popularity, and the like of VOD content. The allocation of channel number may vary according to a user request.

The processor 53 may be configured to allocate channel numbers of channels with respect to a plurality of VOD contents to be different from channel numbers of terrestrial channels, cable channels, and satellite channels. However, this is only an example, and the channels with respect to a plurality of VOD contents may be allocated in between terrestrial channels, cable channels, and satellite channels and have channel numbers that are adjacent to each other.

Further, the processor 53 may be configured to generate not only information corresponding to a VOD content but also integrated schedule information which includes not only the channel corresponding to a VOD content but also schedule information corresponding to terrestrial channels, satellite channels, and cable channels based on information corresponding to EPG information.

When generating integrated schedule information, the processor 53 may be configured to allocate, regardless of the source of content, channel numbers of a plurality of channels to a plurality of channel groups and allocate channels which are included in a same channel group to similar channel numbers according to a type of content. For example, the processor 53 may be configured to allocate channels that provide contents related to current affairs to a first channel group, and allocate channel numbers of between channel numbers 1 to 20 to the first channel group. The processor 53 may be configured to allocate channels that provide news-related contents to a second channel group, and allocate channel numbers of between channel numbers 21 to 40 to the second channel group.

The processor 53 may also be configured to store generated schedule information or integrated schedule information on the database 55 and to control the communicator 51 to transmit the schedule information to the external electronic apparatus 100 according to a user request or a predetermined cycle.

The aforementioned content providing method of the electronic apparatus may be embodied as a program executable by a computer, and the program may be stored in a non-transitory computer readable medium.

A non-transitory computer readable medium refers to a computer readable medium that stores data. The aforementioned various applications or programs may be stored in a non-transitory computer readable medium such as a CD, a DVD, a hard disk, a Blu-ray disk, a USB stick, a memory card, and a ROM, or the like.

Although example embodiments of the present disclosure have been illustrated and described, it should be understood that the present disclosure is not limited to the disclosed example embodiments and may be variously changed without departing from the spirit and the scope of the present disclosure. Therefore, the present disclosure should be construed as including all the changes, equivalents, and substitutions included in the spirit and scope of the present disclosure.

What is claimed is:

1. A method of providing a content in an electronic apparatus, the method comprising:
receiving schedule information from an external server, wherein the schedule information includes information on a plurality of VOD contents allocated to a plurality of channels;
accessing, in response to receiving a command to select a channel corresponding to a first VOD content from among the plurality of VOD contents, a content providing server based on address information of the first VOD content included in the schedule information;
receiving the first VOD content beginning from a screen corresponding to a time point of when the command is input; and
outputting the received first VOD content.

2. The method as claimed in claim 1, wherein the schedule information comprises a channel number, a channel name, a name of a program to be broadcasted for each time slot, and address information of the program to be broadcasted for each time slot.

3. The method as claimed in claim 1, wherein the schedule information further comprises schedule information of at least two of a plurality of channels corresponding to the plurality of VOD contents, terrestrial channels, satellite channels, and cable channels.

4. The method as claimed in claim 1, further comprising:
providing an integrated channel list including at least one of the plurality of channels corresponding to the plurality of VOD contents, the terrestrial channels, the satellite channels, and the cable channels.

5. The method as claimed in claim 1, wherein the first VOD content comprises at least one program, and
wherein the outputting comprises outputting a program from among the plurality of first VOD content on a screen beginning from a time point when the command is input.

6. The method as claimed in claim 5, wherein the outputting comprises including and outputting a UI to control a reproduction time point of the first VOD content on the screen, and
wherein the method further comprises:
controlling a reproduction time point of the first VOD content and outputting the first VOD content, in response to a command being input through the UI to change a reproduction time point of the first VOD content.

7. The method as claimed in claim 5, wherein the outputting comprises outputting a program list to select a program different from a program of the first VOD content together with the first VOD content currently being output on the screen.

8. The method as claimed in claim 5, wherein the outputting comprises outputting a display item to identify information related to the first VOD content together with the first VOD content currently being output on the screen.

9. The method as claimed in claim 5, wherein the outputting comprises outputting, in response to the selected program of the first VOD content being a subscription-based program, a payment menu to view the selected program of the first VOD content.

10. An electronic apparatus comprising:
communication circuitry configured to communicate with an external apparatus;
input circuitry configured to receive a command;
output circuitry configured to output content; and
a processor configured to control the communication circuitry to receive schedule information from an external server, wherein the schedule information includes information on a plurality of VOD contents allocated to a plurality of, to control, in response to a command received by the input circuitry for selecting a channel corresponding to a first VOD content from among the plurality of VOD contents, the communication circuitry to access a content providing server based on address information of the first VOD content included in the schedule information and to receive a first VOD content beginning from a time point when the command is input, and to control the output circuitry to output the received first VOD content.

11. The apparatus as claimed in claim 10, wherein the schedule information comprises a channel number, a channel name, a name of a program to be broadcasted for each time slot, and address information of the program to be broadcasted for each time slot.

12. The apparatus as claimed in claim 10, wherein the schedule information further comprises schedule information of at least two of a plurality of channels corresponding to the plurality of VOD contents, terrestrial channels, satellite channels, and cable channels.

13. The apparatus as claimed in claim 12, wherein the processor is configured to provide an integrated channel list including at least one of the plurality of channels corresponding to the plurality of VOD contents, the terrestrial channels, the satellite channels, and the cable channels and to control the output circuitry to output the integrated channel list.

14. The apparatus as claimed in claim 10, wherein the first VOD content includes at least one program, and
wherein the processor is configured to control the output circuitry to output a screen of a program from among the plurality of programs of the first VOD content beginning from a time point of when the command is input.

15. The apparatus as claimed in claim 14, wherein the processor is further configured to control the output circuitry to include and output a UI to control a reproduction time point of the first VOD content on the screen, and to control, in response to a command being input through the UI to change a reproduction time point of the first VOD content, the output circuitry to control a reproduction time point of the first VOD content and to output the first VOD content.

16. The apparatus as claimed in claim 14, wherein the processor is further configured to control the output circuitry to output a program list to select a program different from a program of the first VOD content together with the first VOD content currently being output on the screen.

17. The apparatus as claimed in claim 14, wherein the processor is further configured to control the output circuitry to output a display item to identify information related to the first VOD content together with the first VOD content currently being output on the screen.

18. The apparatus as claimed in claim 14, wherein the processor is further configured to, in response to the selected program of the first VOD content being a subscription-based program, control the output circuitry to output a payment menu to view the selected program of the first VOD content.

19. A schedule information providing server comprising:
communication circuitry configured to receive information on a plurality of VOD contents from an external content providing server; and
a processor configured to allocate the plurality of VOD contents to a plurality of channels based on the information on a plurality of VOD contents received from the external content providing server, to generate schedule information on the plurality of VOD contents allocated to the plurality of channels, and to control the communication circuitry to transmit the generated schedule information to an external electronic apparatus.
